(19) United States
(12) Patent Application Publication
(10) Pub. No.: US 2003/0114201 A1
(43) Pub. Date: Jun. 19, 2003

(54) Over-the-ear type headset

(75) Inventors: Kwang Chun Chung, Ahnsan-shi (KR); Nam Chul Lee, Ahnsan-shi (KR); Jeong Hyeong Cho, Ahnsan-shi (KR); Byung Yong Song, Ahnsan-shi (KR); Seong Kang, Ahnsan-shi (KR); Hyeong Hu Kim, Ahnsan-shi (KR)

Correspondence Address: William H. Logsdon, WEBB ZIESENHEIM LOGSDON ORKIN & HANSON, P.C., 700 Koppers Building, 436 Seventh Avenue, Pittsburgh, PA, 15219-1818, US

(73) Assignee: INKTEC CO., LTD., Ahnsan-shi (KR)

(21) Appl. No.: 10/038,513

(22) Filed: Jan. 3, 2002

(30) Foreign Application Priority Data
Dec. 18, 2001 (KR) 20-2001-0039105

(51) Int. Cl. H04M 1/00

(52) U.S. Cl. 455/568; 379/430

(57) ABSTRACT

An over-the-ear type headset having a hanger capable of being selectively bent and positioned to afford easy and comfortable wearing regardless of a size and a shape of the ear, and an end-cap having a bulging portion adapted to rest on a recess region below a user's ear to assure stable support of the headset is disclosed. The headset includes a headset body containing an earphone and a microphone, and a hanger coupled to the headset body, which is adapted to be bent along a back of a user's ear.

### BACKGROUND OF THE INVENTION

1. Field of the Invention

The present invention relates to an over-the-ear type headset, and more particularly, to an over-the-ear type headset having a ductile hanger capable of being easily bent and selectively positioned, thereby allowing the headset to be easily worn on a user's ear and to be maintained in its initial stable and comfortable wearing position.

2. Description of the Prior Art

In general, a communications equipment such as a cellular phone is used together with various accessories. Of such communications equipments, headsets serving as hand-free devices are gradually becoming widespread since they allow users to communicate with others while enabling their hands to be freely used for other works.

A telephone communications headset has an earphone and a microphone. Most of the prior art headsets are designed to be worn on a user's head or a back of a user's neck in use. In such headsets, members enclosing earphones are adapted to fully cover users' both ears.

This type of headset, which has members fully covering a user's both ears, is worn regardless of telephone communication or only in case that a user is communicating with somebody over the telephone. A problem with the former case is that the user may not clearly hear voices of others, causing conversation with them to be poorly conducted because he wears the headset all the time, while a problem with the latter is that a user must put on the headset for every telephone communication, causing the user to be inconvenienced.

Recently, over-the-ear type headsets have become widely used, which are adapted to be worn on either one of a user's ears for overcoming the above-mentioned problems.

Referring to FIG. 1, there is shown such an over-the-ear type headset as disclosed in PCT No. WO 00/19685. The over-the-ear type headset includes a speaker module 30 adapted to be comfortably seated over an ear-hole of a user's ear, which houses a miniaturized speaker for outputting an audio signal, an earpiece 20 coupled to the speaker module 30 via a ball-and-socket, which is configured to rest over the outer portion of the ear, and a flexible microphone boom 30 coupled to the earpiece 20 and having a microphone, which functions to receive an audio signal.

The earpiece 20 comprises a rigid backbone 22 resting on the back of a user's ear, and a ductile wire 24 coupled to the rigid backbone 22. The earpiece 20 is designed to be easily worn by a user regardless of whether a user's ear is large or small by bending the ductile wire 24 to fit a user's ear size and shape.

However, since the over-the-ear type headset disclosed in the above PCT No. WO00/19685 has the backbone 22 made of rigid material, the backbone area 22 of the headset is difficult to stably rest on the back of a user's ear where the ear is larger than the standard size, and puts pressure on the back of an ear even if the backbone area rests on the back of an ear. In addition, when a back of an ear is smaller than the standard size, the backbone 22 rubs against a back of an ear while being in contact therewith, thereby causing a user to suffer skin abrasion and pain.

### SUMMARY OF THE INVENTION

Accordingly, the present invention has been made keeping in mind the above problems occurring in the prior art, and an object of the present invention is to provide an over-the-ear type headset having a ductile hanger which is able to be selectively bent and positioned to conform with an ear size and shape of a user, thereby allowing the headset to be easily and comfortably worn regardless of a size and a shape of the ear.

It is another object of the present invention to provide an over-the-ear type headset having a ductile hanger which is bulged at its end so that the headset can be maintained in its initial stable position without displacement and afford a comfortable wearing feeling despite being worn for a long time.

In order to accomplish the above object, the present invention provides an over-the-ear type headset comprising: a headset body containing an earphone and a microphone; and a hanger coupled to the headset body, which is adapted to be bent along a back of a user's ear.

The headset of the present invention may include an end-cap coupled to an end of the hanger and having a bulging portion which is radially enlarged.

The headset body may comprise a housing containing the earphone at an upper part and the microphone at a lower part.

The headset body may include a button for operating the ON/OFF switch associated with the earphone and the microphone, which is projected from the housing.

The hanger may comprise a core having an internal passage which is comprised of an iron wire wound into a spiral spring shape, a filler wound on the core to be positioned in a groove between adjacent wires, and a sheath surrounding the core and the filler.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing a prior art over-the-ear headset;

FIG. 2 is an elevation view showing an over-the-ear type headset according to the present invention;

FIG. 3 is an exploded view of a housing of the headset according to the invention;

FIG. 4 is a cross-sectional view of a housing body of the headset according to the invention;

FIG. 5 is a cross-sectional view of an end-cap of the headset according to the invention;

FIG. 6 is a cross-sectional view of a hanger of the headset according to the invention; and

FIG. 7 is a view showing the headset of the invention in a state where it is worn on a user's ear.

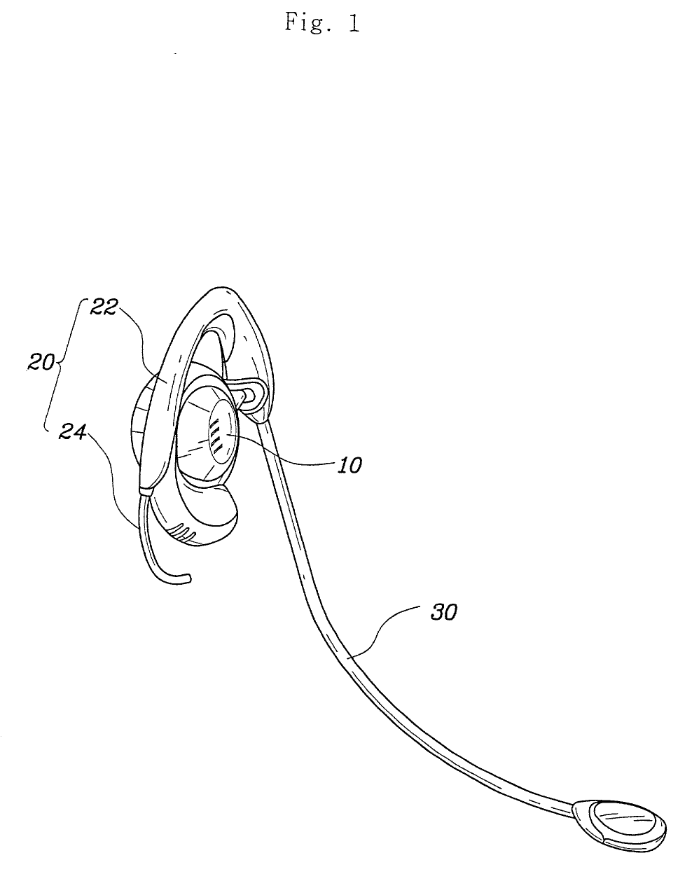

### DETAILED DESCRIPTION OF THE INVENTION

This invention will be described in further detail by way of example with reference to the accompanying drawings.

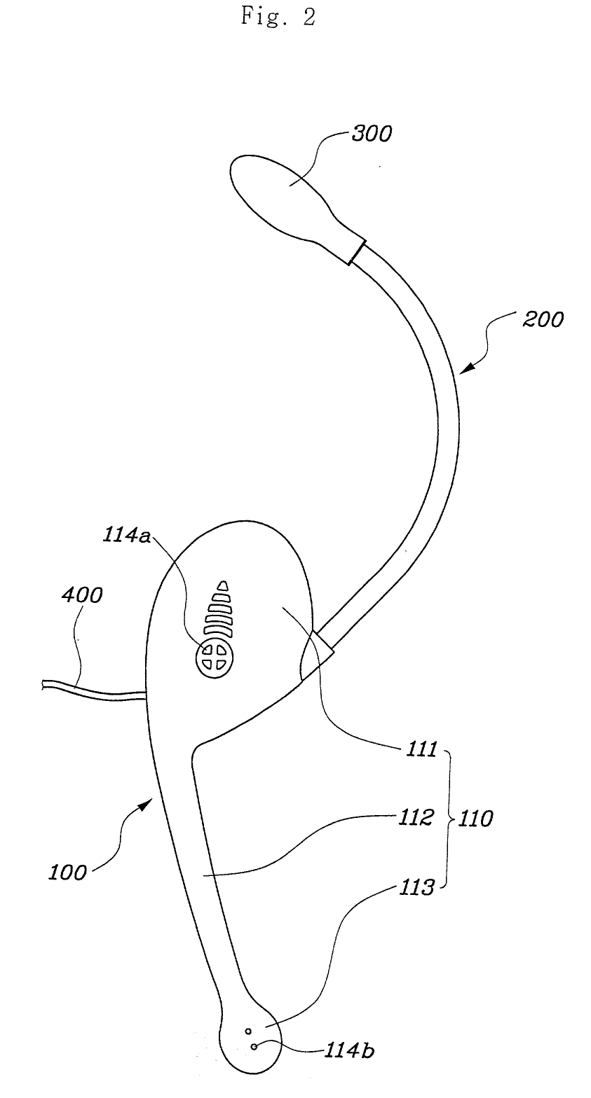

FIG. 2 is a plan view showing an over-the-ear type headset according to the present invention.

The over-the-ear type headset includes a headset body 100 containing an earphone and a microphone, and a ductile hanger 200 coupled to the headset body 100. The ductile hanger 200 is adapted to be selectively bent and rest over the outer portion of the ear.

The ductile hanger 200 is further provided at its end with an end-cap 300.

The headset of the present invention may be used in wireless or wired way. In case of the latter, the headset 100 is provided at a predetermined region with a wire 400 which is connected at its end to the built-in earphone and microphone. The other end of the wire 400 is connected to a communication device.

The headset body 100 is comprised of a housing 110. The housing 110 comprises an upper housing 111 which is sized to cover a majority of an outer ear or at least an area surrounding a user's ear hole and contains the microphone therein, a lower housing 113 close to a periphery of a user's mouth which contains the microphone therein, and an intermediate housing 112 connecting the upper housing 111 to the lower housing 113.

The housing 110 is configured to define an outline of the headset 100 and to support other components to be described later. The housing 110 is preferably made from light material which can be mass produced by an injection molding process.

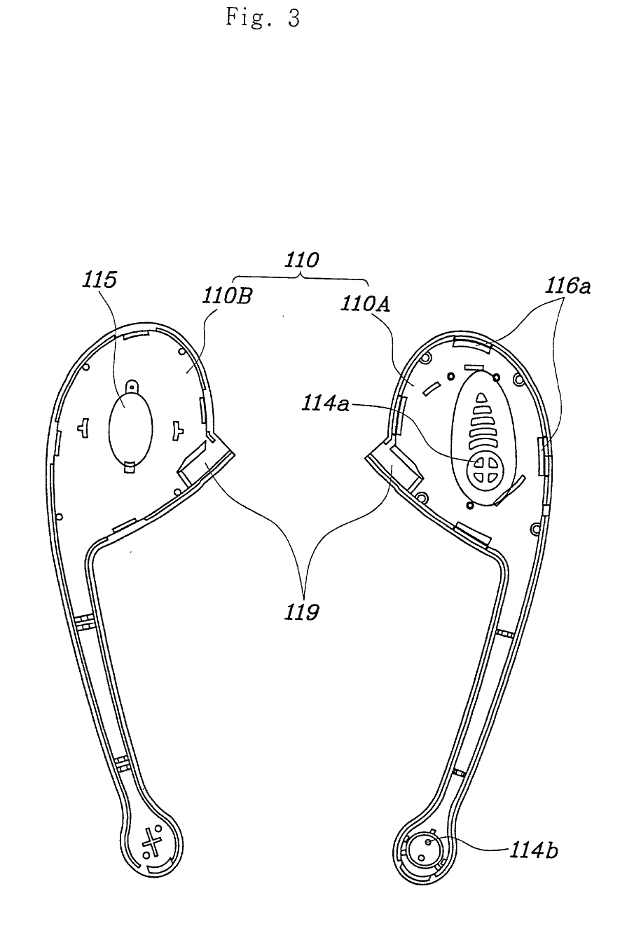

Referring to FIG. 3, there is shown the housing 110 divided into two mating housing halves 110A and 110B.

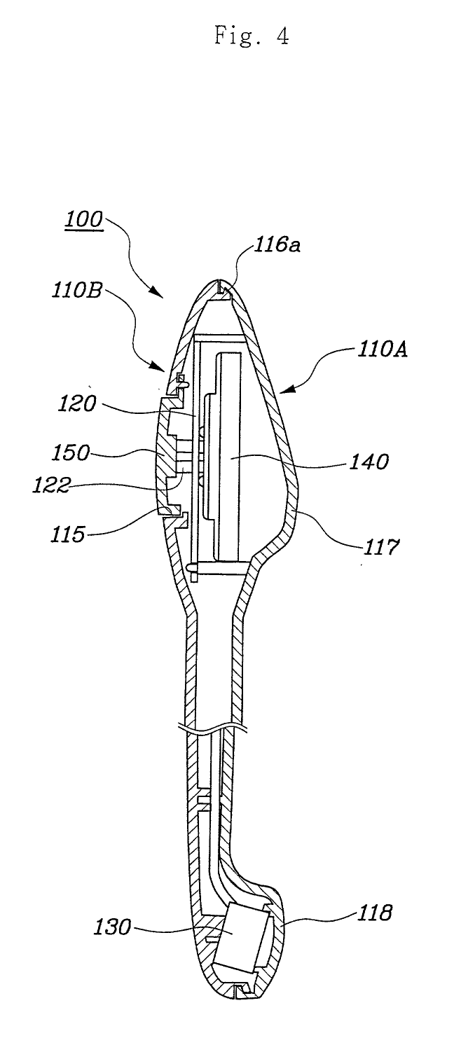

As shown in FIG. 4, the housing halves 110A and 110B are provided with a plurality of protruded hooks 116a, and fitting grooves 116b in which the hooks 116a are resiliently fitted.

The housing half 110A, which faces the user when the over-the-ear type headset is worn on an ear of a user, is provided with earphone holes 114a which allows voice signal outputted from the earphone to be introduced into a ear hole of the user, and with microphone holes 114b which allows the voice of the user to enter the microphone therethrough.

Of course, the earphone holes 114a are located at an upper part of the housing 110A and the microphone holes 114b are located at a lower part of the housing 110A.

The earphone holes 114a and the microphone holes 114b preferably have diameter large enough to allow sound to be easily passed therethrough. It is preferable that the earphone holes 114a and the microphone holes 114b are shaped as one large hole, rather than plural small holes and aesthetically distributed.

The other housing half 110B to be assembled with the housing half 110A is provided with a button hole 115. The button hole 115 is adapted to allow a button described later to be inserted therethrough.

Referring to FIG. 4 which is a cross-sectional view of the headset body 100, there is shown the mating housing halves 110A and 110B and a PCB 120, the microphone 130 and the earphone 140 housed in the space between the fitted housing halves 110A and 110B.

It is preferable that the housing half 110A, which faces a face of a user when the headset is worn on a user, includes the upper housing which is sized to only cover an area surrounding a ear hole of an ear rather than a whole outer ear.

The housing 110A is provided with an upper bulging portion 117 and a lower bulging portion 118 which are protruded toward a face of a user. The upper bulging portion 117 is preferably shaped such that its shape is appropriate to a curve of a user's ear to give the user a comfortable wearing feeling.

The microphone 130 is positioned in a space defined by the lower bulging portion 118 of the housing half 110A, and the earphone 140 is positioned in a space defined by the upper bulging portion 117 of the housing half 110A.

The housing half 110B is outwardly bulged at its upper part to assure a space for housing the PCB 120 therein. The bulged upper part is centrally formed with the button hole 115 through which the button 150 can be moved relative to the PCB 120.

The PCB 120 includes an electrical circuit connected to a communication device, and electrically connected to the earphone 140 and the microphone 130 via electrical wires.

The PCB 120 is provided with an ON/OFF switch 122 which functions to activate or deactivate the electrical circuit of the PCB 120 to cause an audio signal to be transmitted between the earphone 140 and the microphone 130 and a communication device or to be shut off.

The ON/OFF switch 122 is adapted to be actuated by relative movement of the button 150 with respect to the PCB 120.

Of course, the button 150 must be a little projected from the housing half 110B so that the button 150 can be pushed by a user's finger.

The ductile hanger 200 is fitted at its end in a connecting hole 119 with a circular section. An external diameter of the hanger 200 is preferably set to be a little larger than an internal diameter of the connecting hole 119 so that the hanger 200 is hard to pull out of the connecting hole 119 after insertion of the hanger 200.

The connecting hole 119 may be formed at either one of the housing halves 110A and 110B, or may be constructed by distributing hole halves to both the housing halves 110A and 110B such that the hole halves form a complete circular hole after the housing halves 110A and 110B are fitted to each other, as shown in FIG. 3.

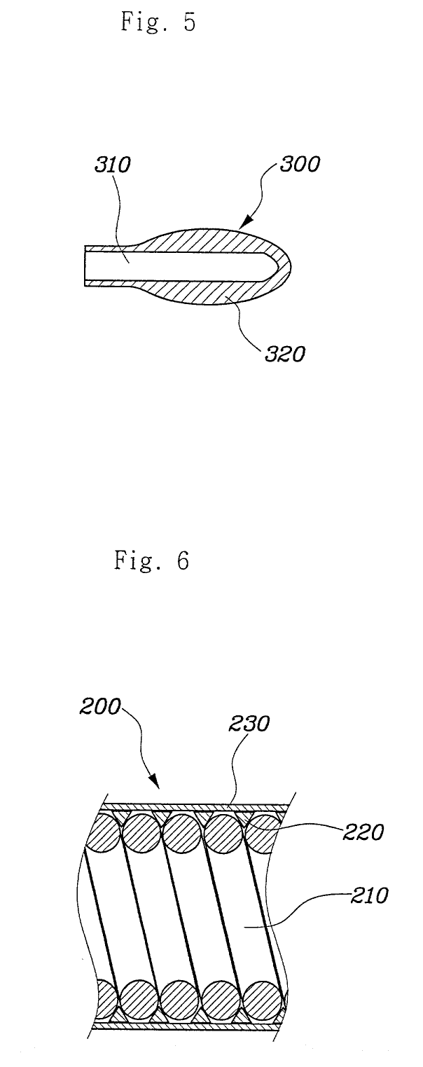

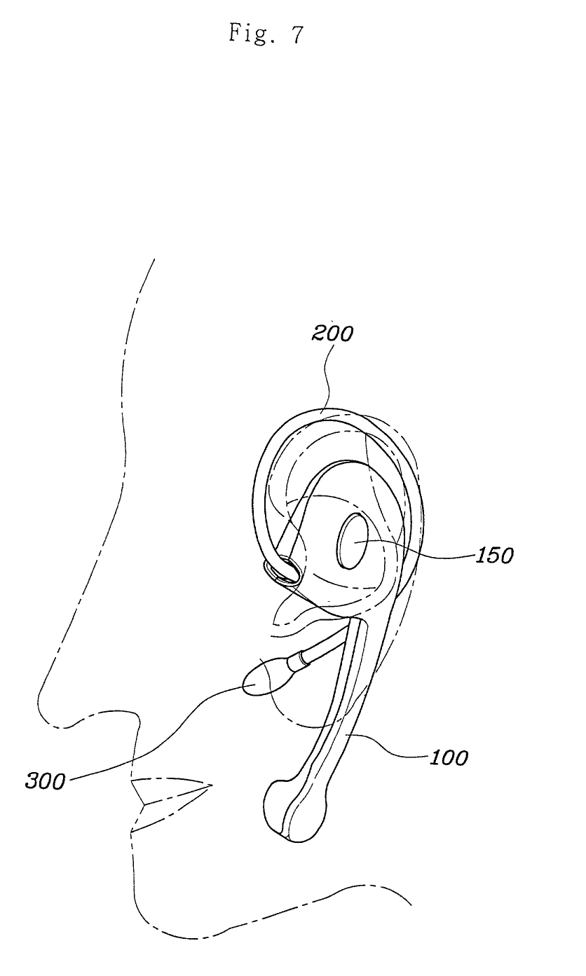

FIG. 5 is an enlarged cross-sectional view of the hanger 200. As shown in the drawing, the hanger 200 comprises a linear core having an internal passage which is comprised of an iron wire wound into a spiral spring shape, a filler 220 wound on the core 210, and a sheath surrounding the core 210 and the filler 220.

The iron wire constituting the core 210 is preferably wound tightly such that there is no space between adjacent loops, and the filler 220 is preferably wound along a groove defined between adjacent loops of the wire.

The filler 220 has a triangular shape in section with an inwardly angled point being positioned in a groove of the core 210 such that an outer surface of the filler 220 flushes with the outermost surface of the wire of the core, thereby achieving a smooth outer circumferential surface of the wire.

The sheath 230 is made from polyethylene (PE) and surrounds the outer surfaces of the filler 220 and the core 210. The sheath 230, i.e., polyethylene does not cause out skin irritation when in contact with a skin of a user's face.

The hanger 200 is capable of being bent to conform to an outline of a back of a user's ear. At this point, the hanger 200 must have appropriate physical properties such that a user does not feel pain by application of excessive force from the hanger.

Furthermore, it is preferable that the hanger 200 is capable of maintaining its initial bent position even during intensive activity of a user.

FIG. 5 is a cross-sectional view showing the end-cap 300 provided at a free end of the hanger 200. The end-cap 300 is adapted to rest in the natural hollow below an ear when the headset is worn on the ear, thereby preventing the headset from being shaken and giving the user a comfortable wearing feeling.

The end-cap 300 is made from resin such as ABS resin, and has a longitudinal hole 310 into which the hanger 200 is inserted at its free end.

Of course, it is preferable that an external diameter of the hanger 200 is a little larger than an internal diameter of the hole 310 of the end-cap 300 so that the end of the hanger 200 is forcibly inserted into the hole 310 to assure secure connection therebetween.

The end-cap 300 is designed to have an appropriate size and shape such that the end-cap 300 does not apply excessive pressure to the recess area below an ear.

That is, the end-cap 300 is provided with a bulging portion 320 to be snugly seated in a hollow below an ear. The bulging portion 320 preferably has an arc shape in longitudinal section.

The bulging portion 320 of the end-cap 300 may be provided only at an area facing a user's head when the user wears the headset. In this case, the hanger 200 must not be twisted when being bent so that the bulging portion 320 of the end-cap 300 faces toward the user's head at any time.

Alternatively, the bulging portion 320 may be provided at a whole circumferential surface of the end-cap 300. In this case, it is not necessary to be concerned about twisting of the hanger 200.

As described above, the present invention provides an over-the-ear type headset having a ductile hanger which is capable of being selectively bent and positioned to conform with the shape of an ear of a user, thereby allowing the headset to be easily and comfortably worn on the user's ear regardless of a size and a shape of the ear.

Furthermore, since the hanger is provided at its end with an end-cap having a bulging portion adapted to rest on a recess region below a user's ear, the headset can be maintained in its initial comfortable position while the user engage in physical activity.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An over-the-ear type headset comprising:
a headset body containing an earphone and a microphone; and
a hanger coupled to the headset body, which is adapted to be bent along a back of a user's ear.

2. The over-the-ear type headset as set forth in claim 1, further comprising an electrical wire connected to the earphone and the microphone for allowing audio signals to be transmitted to and from the earphone and the microphone.

3. The over-the-ear type headset as set forth in claim 1, further comprising an end-cap coupled to an end of the hanger and having a bulging portion which is radially enlarged.

4. The over-the-ear type headset as set forth in claim 3, in which the bulging portion is provided only at an area of the end-cap which faces toward a user's head when the hanger is bent along a back of a user's ear.

5. The over-the-ear type headset as set forth in claim 1, in which the headset body comprises a housing containing the earphone at an upper part and the microphone at a lower part.

6. The over-the-ear type headset as set forth in claim 5, in which the housing is provided with a bulging portion at an inner surface corresponding to an ear hole of a user's ear.

7. The over-the-ear type headset as set forth in claim 1, in which the hanger comprises a core having an internal passage which is comprised of an iron wire wound into a spiral spring shape, a filler wound on the core to be positioned in a groove between adjacent loops of the wire, and a sheath surrounding the core and the filler.

8. The over-the-ear type headset as set forth in claim 7, in which the sheath is made from polyethylene.
